(19) United States
(12) Patent Application Publication
(10) Pub. No.: US 2018/0296953 A1
(43) Pub. Date: Oct. 18, 2018

(54) NON-WOVEN FABRICS COMPRISING ACETATE FIBERS AND THEIR USE

(71) Applicant: RHODIA ACETOW GMBH, Freiburg (DE)

(72) Inventor: Dirk Hölter, Emmendingen (DE)

(21) Appl. No.: 15/766,941

(22) PCT Filed: Oct. 7, 2016
(86) PCT No.: PCT/EP2016/073945

§ 371 Date: Apr. 9, 2018

Related U.S. Application Data
(60) Provisional application No. 62/238,270, filed on Oct. 7, 2015.

(51) Int. Cl. B01D 39/18; D01F 2/28; D04H 1/4258

(52) U.S. Cl. CPC B01D 39/18; D01F 2/28; D04H 1/4258; D10B 2201/28; D10B 2505/04; A23L 2/72; B01D 2239/025; B01D 2239/0407; B01D 2239/0442; B01D 2239/0618; D10B 2401/13

(57) ABSTRACT

This application relates non-woven fabrics comprising cellulose acetate fibers and their use.

This application claims priority to U.S. provisional application No. 62/238270, the whole content of this application being incorporated herein by reference for all purposes.

This application relates to non-woven fabrics comprising cellulose acetate fibers and their use.

Non-woven fabrics are widely used in industry due to their favorable characteristics and the often reduced manufacturing effort; any weaving, for example, is eliminated.

Cellulose acetate fibers are known as basis for the manufacture of cigarette filters, illustrated, for example, in U.S. Pat. No. 3,800,676. Cellulose ester fibers comprised in a fibrous substrate are described in WO2014046680.

It has now been found that non-woven fabrics comprising cellulose acetate fibers can be used for wet or dry filtration. The fabrics can be well adapted to the use, such as adaptation of stiffness, permeability, size, pore size, geometric form and addition of auxiliary additives, such as anti-microbial or catalytic additives. The fabrics thus comprise fibers that are made from renewable sources and are often disposed of in an environmentally and economically favorable fashion. Synergies have also been observed, as cellulose acetate fibers can reduce or remove certain impurities from a gas or a liquid by virtue of their chemical composition and high specific surface area.

Thus, the invention concerns the use of a non-woven fabric comprising cellulose acetate fibers for wet or dry filtration. The invention further concerns a non-woven fabric comprising equal to or more than 40 weight %, preferably equal to or more than 50 weight % and more preferably equal to or more than 60 weight % of cellulose acetate fibers.

The term « cellulose acetate»intends to denote a cellulose acetylated to a degree of substitution (DS) from 0.2 to equal to or less than 3. Cellulose acetate can be made according to procedures known to the person skilled in the art, for example by reacting cellulose with acetic acid anhydride, optionally in the presence of a catalyst such as an acid.

In one aspect of the present invention, the fabric for the use according to the invention generally comprises equal to or more than 40 weight %, preferably equal to or more than 50 weight % and more preferably equal to or more than 60 weight % of cellulose acetate fibers.

In one aspect, at least a fraction of the cellulose acetate fibers comprised in the non-woven fabric, which is used in the present invention for filtration, has a cross section of trilobal shape. In a preferred aspect, equal to or more than weight 40%, preferably equal to or more than 50 weight % and more preferably equal to or more than 60 weight % of the cellulose acetate fibers comprised in the non-woven fabric have a cross section of trilobal shape. In another aspect, at least a fraction of the fibers has other cross sectional shapes, for example round, multi-lobal, 1-beam or dog bone.

According to one aspect of the present invention, at least a fraction of the cellulose acetate fibers comprised in the non-woven fabric, which is used in the present invention for filtration, is in the form of submicron fibers. In a preferred aspect, equal to or more than 1 weight %, or equal to or more than 5 weight % or equal to or more than 10 weight % of the cellulose acetate fibers comprised in the non-woven fabric are in the form of submicron fibers. Often, the weight % of submicron fibers comprised in the non-woven fabric does no exceed 50 or 60 weight %. The term «submicron » intends to denote fibers with a mean diameter of less than 1000 nm. In a particular aspect, the cellulose acetate fibers have a mean diameter preferably of less than 100 nm; such fibers are often denoted as «nanofiber ». Often, the mean diameter of such nanofibers is equal to or larger than 10 nm, preferably 50 nm. The mean fiber diameter can be determined according to methods known to the person skilled in the art, for example by SEM (scanning electron microscopy) images.

According to one aspect of the present invention, the geometric form of the non-woven fabric has at least three, preferably four, angles. This intends to describe a non-cylindrical form of the fabric to be used in filtration. In one aspect, the fabric is folded for the use.

According to one aspect of the present invention, the fabric is formed into cylindrical shape, for example for use in air or liquid filtration cartridges.

The non-woven fabric can be made by layering and/or fanning the fibers comprising cellulose acetate fibers. This can be achieved, for example, by a wet laid process, a dry laid process, such as air laid or carded. Subsequently, for example, heat and/or pressure and/or a bonding agent, for example polymers (e.g. phenolic resins) which are melted onto the fibers, and/or a plasticizer, for example triacetin, and/or a solvent, for example acetone, is/are applied to pre-treat and/or bind the layered and/or fanned fibres. The fabric is then obtained, optionally after forming the pre-treated fibers into a desired shape, by leaving the heated fibers or bonding agents, for example melted phenolic resins, to set, and/or the plasticizer to bind the fibers and/or the solvent to evaporate. In another aspect, the fibers are interconnected by needle punching to form the fabric.

Optionally, at least one additive such as antimicrobial or catalytic additives are supplied to the fibers before or after pre-treating the fibers during the process of manufacturing the non-woven fabrics from the fibers. In another aspect, at least one additive such as antimicrobial or catalytic additives are already incorporated into the fibers during the fiber manufacturing process. In yet another aspect, the at least one additive is heat-sensitive.

In one aspect of the present invention, the use is a dry filtration, wherein the dry filtration is a gas filtration, in particular air filtration. In particular, the gas filtration, preferably air filtration, reduces or eliminates particulate, microbiological or chemical contaminants in the gas. In one aspect, the content of an aromatic chemical contaminant, in particular phenol, is reduced in the gas.

In a preferred aspect of the present invention, the air or gas which is filtered comprises equal to or more than 12 Vol % of oxygen and equal to or more than 74 Vol % of nitrogen. In contrast, for example, cigarette smoke comprises, at the incineration location, up to 73 Vol % of nitrogen and about 10 Vol % of oxygen. In this aspect, the gas or air which is filtered is not cigarette smoke as measured directly from the tobacco incineration location. The gas or air to be filtered may, though, comprise cigarette smoke in a diluted concentration.

In one aspect, the fabric is part of an HVAC (heating, ventilating and air conditioning) system, which is generally connected to stationary systems, such as indoor air conditioning, or an automotive system.

According to the present invention, advantageously the use is a wet filtration, wherein the wet filtration is a liquid filtration, in particular aqueous or non-aqueous filtration. In one aspect, the filtration reduces or eliminates particulate, microbiological or chemical contaminants in the liquid, in particular in oil or aqueous systems, in particular in beverages or waste water.

The invention further concerns a non-woven fabric comprising equal to or more than 40 weight %, preferably equal to or more than 50 weight % and more preferably equal to or more than 60 weight % of cellulose acetate fibers. In one aspect, at least a fraction of the cellulose acetate fibers comprised in the non-woven fabric, has a cross section of trilobal shape. In a preferred aspect, equal to or more than 40 weight %, preferably equal to or more than 50 weight % and more preferably equal to or more than 60 weight % of the cellulose acetate fibers comprised in the non-woven fabric have a cross section of trilobal shape. In another aspect, at least a fraction of the fibers has other cross sectional shapes, for example round, multi-lobal, 1-beam or dog bone.

In a preferred aspect, equal to or more than 1 weight %, or equal to or more than 5 weight % or equal to or more than 10 weight % of the cellulose acetate fibers comprised in the non-woven fabric are in the form of submicron fibers. Often, the weight % of submicron fibers comprised in the non-woven fabric does no exceed 50 or 60 weight %. The term «submicron » intends to denote fibers with a mean diameter of less than 1000 nm. In a particular aspect, the cellulose acetate fibers have a mean diameter preferably of less than 100 nm; such fibers are often denoted as «nanofiber ». Often, the mean diameter of such nanofibers is equal to or larger than 10 nm, preferably 50 nm. The mean fiber diameter can be determined according to methods known to the person skilled in the art, for example by SEM (scanning electron microscopy) images.

In one aspect, the non-woven fabric according to the invention has a geometric shape which has at least three, preferably angles, and/or has a rectangular shape. In one aspect, the fabric is folded.

In another aspect, the non-woven fabric according to the invention has a geometric shape which is cylindrical.

In one aspect, the non-woven fabric according to the invention further comprises at least one anti-microbial or catalytic additive. The additive can be heat sensitive.

In one aspect, the cellulose acetate fibers have, for example, a density of 1.32 g/cm³, a tenacity of 10-13 cN/tex, a tensile modulus of 2.9 N/tex and a melting point of 255-260° C. They can also be water absorptive.

Should the disclosure of any patents, patent applications, and publications which are incorporated herein by reference conflict with the description of the present application to the extent that it may render a term unclear, the present description shall take precedence.”

1. A method comprising applying a non-woven fabric comprising cellulose acetate fibers in a wet or dry filtration process.

2. The method according to claim 1, wherein the fabric comprises equal to or more than 40 weight %, preferably equal to or more than 50 weight % and more preferably equal to or more than 60 weight % of cellulose acetate fibers.

3. The method according to claim 1, wherein the filtration process is a dry filtration, wherein the dry filtration is a gas filtration, in particular air filtration, preferably wherein the gas comprises equal to or more than 12 Vol % of oxygen and equal to or more than 74 Vol % of nitrogen.

4. The method according to claim 3, wherein the filtration reduces or eliminates particulate, microbiological or chemical contaminants in the gas, in particular in air.

5. The method according to claim 3, wherein the content of an aromatic chemical contaminant, in particular phenol, is reduced in the filtration.

6. The method according to claim 3, wherein the fabric is part of an HVAC system or an automotive system.

7. The method according to claim 1, wherein the filtration process is a wet filtration, wherein the wet filtration is a liquid filtration, in particular aqueous or non-aqueous filtration.

8. The method according to claim 7, wherein the filtration reduces or eliminates particulate, microbiological or chemical contaminants in the liquid, in particular in oil or aqueous systems, in particular in beverages or waste water.

9. The method according to claim 1, wherein at least a fraction of the cellulose acetate fibers has a trilobal shape.

10. The method according to claim 1, wherein at least a fraction of the cellulose acetate fibers are nanofibers.

11. A non-woven fabric comprising equal to or more than 40 weight %, preferably equal to or more than 50 weight % and more preferably equal to or more than 60 weight % of cellulose acetate fibers.

12. The non-woven fabric according to claim 11, wherein at least a fraction of the cellulose acetate fibers has a trilobal shape.

13. The non-woven fabric according to claim 11, wherein the geometric shape of the fabric has at least three angles.

14. The non-woven fabric according to claim 11, wherein at least a fraction of the cellulose acetate fibers are nanofibers.

15. The non-woven fabric according to claim 11, wherein the fabric further comprises at least one anti-microbial or catalytic additive.
